(19) United States
(12) Patent Application Publication
(10) Pub. No.: US 2004/0259635 A1
(43) Pub. Date: Dec. 23, 2004

(54) Multiple-sided video display system

(76) Inventor: Michael Peter Germeraad, Saratoga, CA (US)

Correspondence Address: Michael Germeraad, 14606 Horseshoe Dr., Saratoga, CA, 95070, US

(21) Appl. No.: 10/600,583

(22) Filed: Jun. 23, 2003

(51) Int. Cl. A63F 13/00

(52) U.S. Cl. 463/30

(57) ABSTRACT

A multiple-sided video display system containing two or more individual video display screens oriented at angles so that one and only one individual video display screen thereon can be seen by an individual positioned in front of one of the individual video display screens, and so that the face and upper body of all individuals positioned in front of each of the individual display screens can be seen by each other individual positioned at the multiple-sided video display system. The multiple-sided video display system can be used to play video computer games, to watch broadcast television, to connect to the internet, and to watch pre-recorded entertainment in VHS, DVD, MMC or like pre-recorded formats. In the computer game configuration, each user's video screen preferably has its own game controller, speakers and headphones. When the multiple-sided video display system is used for watching broadcast or pre-recorded video content, the person watching one screen can be watching the same or different things compared to the person(s) on the other sides.

### CROSS REFERENCE TO RELATED U.S. APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The field of video display systems relates to the mechanism of producing the video image, the kind of device that converts the electrical signal into an optical image, and the arrangement of the physical devices (visual display systems) that display the optical images to humans. This invention relates to the latter field.

Visual display systems that display optical images to humans have been arranged in many different configurations. They have been single screen devices, single screen devices with multiple “windows” or partitions visible on the single screen, and multiple devices. Multiple devices have been used to show both a single image, each section of the single image being displayed on an individual visual display device, or multiple images, each being displayed on an individual or small group of all the visual display devices in a visual display system.

An example of a single screen device is a standard TV. It shows one program across its entire screen. An example of this single screen device, as related to a computer games, is described in U.S. Pat. No. 5,136,644 to Audebert et. al., entitled “Portable Electronic Device For Use in Conjunction with a Screen”. This patent describes a portable device for enabling player interaction with a program on a screen, typically a television screen. The program can be a televised broadcast, provided by a computer terminal, a telecommunication terminal, or other similar terminal.

An example of single screen devices with multiple “windows” or partitions are TV's with “picture-in-picture” features or a computer with multiple “windows” open at the same time showing the user the outputs from several software applications in overlapping or side-by-side visual images.

An example of multiple screen devices used to show a single image are wall displays of TV's typically used for advertising wherein one visual image is split into sections, each section displayed on a single TV arranged within the wall array. Another example wherein one data image is displayed on multiple video screen displays is airport arrival or departure information. There the single data image is broken into parts, each part of which is displayed on a single wall or ceiling unit in a way that the user sees the whole array of video screen displays as one large data table of information.

Finally, an example of multiple images, each being displayed on an individual or small group of all the visual display devices in a visual display system is in night clubs wherein the wall or ceiling displays are made of arrays of single TV's or computer video units. Sometimes the video images are operated as one large video display device as described above, and sometimes each video display device is sent and displays a separate graphic image. These images can be text or image. U.S. Pat. No. 5,927,985 by Lechner titled “modular video display system” describes a similar system as “A visual display system, such as a flight simulation system, includes a number of display screens and a number of associated video projectors which project predetermined video images on the display screens in response to control signals provided by an operator. In one embodiment, the display screens are circumscribed by an imaginary sphere having a predetermined radius and centered about the design eye of the visual display system. The design eye is generally positioned in a predetermined fixed relation to the operator such that the distortion of the displayed video image is reduced. In another embodiment, the video projectors are mounted in a linear side-by-side relationship on a rear side of the display screens, thereby reducing the overall size of the visual display system.”

The present invention relates to multiple video display devices, including two or more single visual display devices arranged spatially in a way that only one video display of the multiple video display device can be seen at a one time when standing or sitting in front on any one of them. These multiple visual display devices are not intended to be used by the viewer as a single unit, but rather by multiple users each with their own private screen, not seen by the other viewers.

Thus the present invention relates to electronic games in general and in particular to interactive multiple player game systems that are designed to be played by two or more players.

With the video display systems in use today, a person playing a TV or computer game looks only at one screen in front of them or a portion of a screen in front of them if other players are also playing. The problem with these single video display systems in use today is that players have to share one screen. The screen is divided into halves, thirds, or fourths. The player has to look at one small screen. The players also have to deal with other people looking on their screen, and getting information on what they are doing. For example: one player could be in an advantageous competitive position in a computer game, and the other player could look on their screen, and find out where they were. For example in car racing computer games the players can visually see where the other players are on the track, or likewise in computer games where players are located in different parts of a landscape or building and are hunting one another, they can see from the other player's screen where they are and how to better attack or defend themselves. Each player using such a video display device has to cope with other players looking on their screen and not being able to do anything secretive. This is only a problem in multi-player games.

In U.S. Pat. No. 4,521,014 the players know what the other is doing because they are all on the same screen so you could tell what your opponent has done or was about to do. The present invention allows video game players to remain secret from one another and not know from looking at the same video display screen what the other players are doing. As such, they cannot tell what area the other players are in, and therefore they can use surprise against their opponent. With the present invention, you do not need to worry about your opponent knowing where you were, what weapon you were going to use on him, etc., because your opponent can't see your screen.

Other people have tried to solve the problem by making multiple monitors, or by splitting the video display screen of ever-larger single monitors. This addresses the problem with respect to the size of the screen, but does not address the ability of people to see one another directly when playing. In the current configurations in use today, the players sit side-by-side or sit forming a small arc of a semi-circle in front of the large video display device. This has the disadvantage that, for instance, if you were playing a game with another person then you would both be looking at the same screen, and would only be able to easily talk with one another. You cannot see each other's expressions when something happens in the game. This lack of visual information about the other players' emotions reduces the value and entertainment derived from playing games together with another person. The highest value is obtained when players can see one another visually, but not see the images on their video display screens.

Although the art of electronic game systems is well developed this need has yet to be addressed completely. Several recent notable developments include the development of multiple player game systems, enabling two players to play against each other on hand-held game devices by physically connecting the two game devices, and the like. Although this solved some of the problem by using these hand held and laptop computer devices hooked together by LAN or wireless communications, this still has left the problem of players working with small screens, and the expense of multiple computers. Although a single CPU system has been disclosed its implementation did not allow the players to view one another's body position and expressions during play. In particular, U.S. Pat. No. 5,159,549 to Hallman et al, entitled “Multiple Player Game Data Processing System with Wager Accounting” describes a multiple player betting system in which a central processing unit controls a number of player stations to which it is connected by wires. The CPU receives data on an interrupt basis from each of the player stations and regulates the ordered play among competitors. The CPU is responsive to the data for indicating a winner, calculating the accumulated point total or wealth of each of the players and the like. In this work the need for seeing the other player and observing the body language of the other players to maximize enjoyment of the game was not disclosed or commented upon. The technology at the time only allowed for screens and units and did not contemplate the multiple video display system that would be suitable for computer games of today.

An invention that is most similar to mine is U.S. Pat. No. 5,618,045. It is “An interactive multiple player game system including at least two playing devices communicating over an ad-hoc, wireless, all-to-all broadcast network. A playing device includes a processor for running a game scenario common to all of the playing devices within the network, a player controlled interface for enabling a player action within the game scenario, a transmitter for transmitting the player action over the network, a receiver for receiving player actions from other playing devices transmitting over the network, and a display for displaying at least a portion of the game scenario. The interactive multiple player game system can further include a play station device and an interface apparatus for interfacing between the play station device and the playing devices.” The present invention is different from this in that the player's stations comprise the game controller and the video display units. In the present invention it is the unique position of the video display units themselves in a single multi-sided arrangement that provides the user experience not yet provided by prior inventive activities.

Another method previously described in U.S. Pat. No. 5,435,557 by Coffey titled “video game screen divider” talks about “A video-game apparatus that allows the displaying of secret-personalized information to each player of multiple-player-video-games, on one cathode ray tube or CRT. A panel of opaque material partitions the view of a television CRT into two independent areas; a left-side and a right-side. The panel is held vertical and perpendicular in front of the television CRT. There are numerous ways that the panel can be held in front of the CRT. However, in the main embodiment the panel is attached to the surface of the CRT screen by suction cups. Two video-game players, a left-player and a right-player, are positioned so that they can only see their respective side or view of the CRT screen. Images are displayed on the CRT screen so that the left-player's information is displayed on the left-side of the CRT, and the right-player's information is displayed on the right-side. The source of these images could come from computers, home-video game systems, CATV, or broadcast stations.” This again suffers from the disadvantage that the players are seated in a manner in which they can not easily observe one another's body language and their view of the screen is off axis, typically reducing their visual experience as most video display screens are designed for optimal viewing head-on.

Another area where the current use of video display systems is lacking is in airports. Here the current flat wall units cause passengers to congregate in one location in front of the screen. This causes congestion in the corridors and presents security problems because of the close proximity of passengers the current video display systems promote.

An additional area where the current use of multiple video display systems is lacking is in sports bars. Here the current multiple flat wall units and individual units typically suspended from ceilings close to walls make viewing of the sports programs difficult. Only one program can be seen at a time and from only one viewing angle in the room. It also causes the sports bar customers to sit side-by-side instead of facing one another in a way that would promote social interactions and increased sports bar business.

There remains a need for an interactive multiple player game system designed to be played by two or more players each playing on a playing device in communication with other playing devices and displaying information on a multiple-sided video display system.

### BRIEF SUMMARY OF THE INVENTION

The object of the present invention is to provide a multiple-sided video display system for interactive multiple player game systems and a method, therefore, in which two or more players, each playing on their own playing device in wireless or wired communication with the other playing devices, can participate in a game scenario common to all the playing devices in a way that they can each see only their own video display screen (not the other players') and yet see one another's face and upper body. Additionally, the object of the present invention is to provide a viewing system for airports and sports bars wherein customers can view video images and at the same time easily observe one another.

Hence, there is provided, according to the teachings of the present invention, a multiple-sided video display system comprising at least two video display devices connected to an entertainment broadcast network, private entertainment source, or computer game which includes multiple video display screens placed in a central console or unit, that in a fixed or movable configuration, allows viewing of only one of the video display screens by any one person at any time.

The multiple-sided video display system of the current invention may likewise be a multisided box placed on the floor, a unit mounted on a structure placed on the floor so as to raise its viewing height, wall mounted with fixed, moveable, or removable support structures, or ceiling mounted again with fixed, moveable, or removable support structures. There may be one or more multiple-sided video display systems in a room, airport, and sports bar so as to provide multiple viewing stations for users and/or players.

The multiple-sided video display systems contemplated in the present invention include but are not limited to CRT, LED, and LCD video displays. Any device capable of converting and electrical/electronic input into a visual image for human viewing is suitable for use in the present invention. This includes physically moveable arrays of display devices, three dimensional devices and arrays, and single devices that on one viewing side of the present invention's system may be either single, single windowed, or multiple display devices.

The multiple-sided video display systems of the present invention would play pre-recorded movies or other pre-recorded video content, video games, and broadcast television or entertainment channels. Every screen would optionally have its own sound system, be it earphones or speakers, game controller. There would also optionally be a master remote that would control all sides of the product. The multiple-sided video display systems would preferably not be placed next to a wall, but would be placed so that all sides would be visible. The people using the product sit around it on all sides.

Using the sound system of the user would work just the way that users use boom-boxes today. If you put on earphones then each player can only hear the information, sound effects and noise through the earphones, but if you take the earphones off, then the sound will be heard by the other players nearby with today's technology found in today's models of televisions. Optionally speaker systems that focus sound to a particular point in space could be used to allow speakers to be used with each video display device, allowing only the sound associated with that device to be heard by the player or user sitting in front of that particular screen.

In the present invention, video game players would each have their own screen, and would be looking at one another. The players would not be able to look on the other person's screen with the multiple-sided video display system.

The video display system of the present invention can be further enhanced so players would not be able to look on the other person's screen. This enhancement can be done by adding side screens on each person's video screen, or optionally each person's video screen can be equipped with individual screens that are designed so that the information on the video display screen can be viewed only head-on. Such head-on viewing can be done by a lens unit mounted, or made integral, with the video display device. The display unit itself can be also designed with interference optics, so that it can only be viewed without distortion by a person sitting directly in front of it.

In the present invention, when watching movies and television watching, the screens could all be showing different channels, with same or different sound levels, or be showing a compact disk movie while others watch broadcast TV. The advantage of this is everyone could watch what they wanted, but they could still be in the same room, and interact with one another since they are in full view of one another. It would be the same environment, but everyone would get to watch or play what they wanted, or optionally watch the same thing together.

In the present invention, it is also provided that a combination of activities could be present with some individuals playing games together while others watched pre-recorded or broadcast video or audio, while still others were surfing the Internet or working at other computer-based applications.

### BRIEF DESCRIPTION OF THE SEVERAL VIEWS OF THE DRAWING

Not Applicable

### DETAILED DESCRIPTION OF THE INVENTION

The multiple-sided video display system is a structure that consists of two or more individual video display screens. These individual video display screens can be cathode ray tubes, liquid crystal displays, or any other display technology that renders an image to a viewing screen. The individual video display screens are on the sides of the structure. The location of the individual video display screens is such that a person can not see the video images of any screen other that their own, while seated or standing in front of their own screen. They can, however, see the faces and upper bodies of the other individuals standing or seated in front of the other individual video display screens of the multiple-sided video display system.

In the preferred embodiment of the present invention there are earphone adapters for each individual video display screen, along with a small area on each side of the individual video display screen that consists of buttons that control the video and audio output for the corresponding individual(s) viewing the individual video display screen that the controls are on. Each individual video display screen can be used to display a different computer game being used by each person, or sub-set of persons, or all persons playing the same computer game. There is optionally a slot for a VHS tape, (compact disk) CD, (digital video disk) DVD, or MMC (multimedia chip) on each side. The input adapters that are on a normal television today would be placed on the top of each side of the structure. These adapters would allow for a video game console and remote controllers. The individual video display screens can optionally be connected either individually or in combinations to broadcast video and audio inputs, Internet access devices, game computers and devices, or pre-recorded video and audio input devices. The connections can be wired or wireless, electrical or optical similar to those provided in today's television, stereo, home entertainment, and computer games.

The multiple-sided video display system of the present invention can also be used in airports. The arrangement of the present invention can be used to tell passengers if their plane is late, early or on time. The video display units of the present invention would put the video display units in the center of the airport corridors and then passengers would not need to crowd around one flat screen which causes the current problems and security risks of today's approach. The video display units of the present invention would allow everyone to be close to a screen so that they could see. In this configuration the arrival and departure information could be displayed on individual video display screens either in its entirety or in portions, the arrival and departure information spread across several of the individual video display screens.

The multiple-sided video display systems of the present invention can also be used in sports bars. The multiple-sided video display systems would preferably be ceiling mounted or mounted on or in tables so that in either configuration you can observe individuals at other of the individual display screens across from you. The sound systems for these device would preferably employ audio technology to focus the audio output exclusively toward the individuals viewing the corresponding individual video display screens.

The display system of the present invention can further be illustrated by the following examples.

### EXAMPLE 1

To play a computer game the multiple-sided video display system would be placed in an open area. The players would then sit down in front of one of the screens. The screen would show them a full view of their needs, just like in a one-player game, where the player only sees what they would see for each game situation they were in. With the multiple-sided video display system of the current invention each of the players gets his/her own individual screen. They do not share a screen with the other computer game players. But they would be playing against others as their games are electronically tied together by a wireless or wired network of individual computers or a single computer game processor capable of multiple independent video and audio outputs to the multiple-sided video display system of the present invention. The game is played the same as it otherwise would be, but with the multiple-sided video display system each player would have a full view in his/her own screen, and only that screen.

The multiple-sided video display system also lets the players look at one another easily with their peripheral vision and without taking their eyes completely off their own screens. The screen that each player looks at will be different, which allows them to do things on the screen, that are secret, and that other players will not see.

### EXAMPLE 2

To work in an airport the multiple-sided video display system will be used similar to the way in which single screens are currently viewed. They would be in the middle of a room or edges of an open corridor, making it easy for people to look at the screen, without having to crowd around a single screen. The multiple-sided video display system would save space. Being able to see another person in this example is not needed, but it allows people to see what they are looking at without looking over a shoulder.

### EXAMPLE 3

To work in a sports bar the multiple-sided video display system would be placed in the center of the room. The sides of the multiple-sided video display system would be used to show TV broadcast or pre-recorded entertainment channels. The sides could all be tuned to the same channel, or they could be on different channels. For example the multiple-sided video display system would have a basketball game on one channel, a football game, a hockey game, and a baseball game all on different sides. They could also all be tuned to the same program, allowing everyone to see the same program, but also allowing them to see other individual's reactions to a program.

I claim:

1. A multiple-sided video display system comprising, a mounting enclosure, containing two or more individual video display screens oriented at angles so that one and only one individual video display screen thereon can be seen by an individual positioned in front of the individual video display screen, and so that the face and upper body of all individuals positioned in front of the individual display screens can be see each other individual positioned in front of the individual display screens.

2. The process of displaying video broadcast content, internet content, or pre-recorded content utilizing a multiple-sided video display system.

3. The process of displaying computer games utilizing a multiple-sided video display system.

4. A multiple-sided video display system according to claim 1, wherein the video display system is electronically or optically connected via wireless or wired connections to a computer game controller.

5. A multiple-sided video display system according to claim 1, wherein the video display system is electronically or optically connected via wireless or wired connections to a video display computer, broadcast receiver, or pre-recorded content player.

6. A multiple-sided video display system according to claim 1, wherein number of video display devices is three.

7. A multiple-sided video display system according to claim 1, wherein number of video display devices is four.

8. A multiple-sided video display system according to claim 1, wherein number of video display devices is greater than four.
